(19) United States
(12) Patent Application Publication
(10) Pub. No.: US 2014/0084066 A1
(43) Pub. Date: Mar. 27, 2014

(54) PHASE ENCODING IN MICROGRATING-BASED ANTICOUNTEFEIT DEVICES

(71) Applicants: Jesper Glückstad, Frederiksberg (DK); Darwin Palima, Soborg (DK)

(72) Inventors: Jesper Glückstad, Frederiksberg (DK); Darwin Palima, Soborg (DK)

(73) Assignee: DANMARKS TEKNISKE UNIVERSITET, Lyngby (DK)

(21) Appl. No.: 14/004,358

(22) PCT Filed: Apr. 27, 2012
(86) PCT No.: PCT/DK12/50142

§ 371 Date: Nov. 20, 2013

Related U.S. Application Data
(60) Provisional application No. 61/480,505, filed on Apr. 29, 2011.

(30) Foreign Application Priority Data
Apr. 29, 2011 (EP) 11164230.2

(51) Int. Cl. G06K 19/06; G06K 7/14

(52) U.S. Cl. CPC G06K 19/06178; G06K 7/1408
USPC 235/454; 235/494

(57) ABSTRACT

The invention relates to encoding phase information in micro-grating-based anti-counterfeit devices such as diffractive optically variable identification devices (DOVID). The invention utilizes that alignment of grating line positions in different micro-gratings having common line spacing and orientation, can be used as a new, additional information channel in DOVIDs. By displacing grating line positions in different pixels relative to a common reference grating, relative shifts in alignment are introduced that do not affect the visual effects encoded in the DOVID. The relative shifts in line position alignment induce relative shifts in the phase of light diffracted by the DOVID, so as to introduce a spatial phase shift distribution corresponding to the distribution of position shifts over the DOVID. Such spatial phase shift distribution is not visible, and the phase encoded information is thereby invisible unless a reader based on e.g. generalized phase contrast is applied. The phase encoded information can further be phase encrypted so that a spatial phase modulator decryption key is required to read the encoded information.

### FIELD OF THE INVENTION

The invention relates to micro-grating-based anti-counterfeit devices, and more specifically such devices with encoded phase information and a reader for reading such devices, as well as methods for encoding and decoding the phase information.

### BACKGROUND OF THE INVENTION

Anti-counterfeit devices or security labels have long been standard on credit cards, banknotes, passports, and other ID's, and are becoming increasingly popular in other fields such as product labelling. Security labels based on diffractive gratings with advanced visual effects are the most commonly used security label because of the advanced and expensive equipment required for production (and thereby copying). These diffractive grating based labels are generally referred to as diffractive optically variable identification devices (DOVIDs) and popularly also as security holograms (although a hologram is a DOVID, many present security levels are not holograms but synthetic gratings written by other techniques).

2D and 3D holograms, Kinegrams®, and other optically variable security features based on micro-gratings can produce colour and texture in security graphics, not by using pigments, but by using “pixels” that are micro-grating regions. Such pixels with micro-gratings may be produced by the interference of focused laser spots for the so-called 2D/3D holograms (see e.g. U.S. Pat. No. 4,918,469 and U.S. Pat. No. 4,629,282), by electron-beam lithography for high-quality micro-gratings, and can be replicated using micro-grating writing techniques such as the HoloPrint® technique (http://stensborg.com/holoprint).

When illuminated by a white light source, each micro-grating pixel scatters the different colours of light in various directions and so the pixel can appear to change colours when viewed from different directions. A pixel can also appear dark when viewed from a certain angle if the micro-grating does not scatter light along that direction.

A large number of security features for optically diffractive structures are known, and new ones are continuously being developed.

U.S. Pat. No. 6,271,967 relates to grating-based security elements that increases the multiplicity of the encoding options and thus adds yet another security feature. It discloses using pixels, where each pixel has several parts (sub-regions) having identical periodical grating structures except for the parameter of optical depth. The optical depth is then constant over the extent of a sub-region, but is different from the optical depth of the other sub-regions within the pixel. This provides a further control or encoding option in regard to an image impression to be communicated. For example, an image motif produced by sub-regions having one optical depth can appear in one color in one viewing direction, while in another viewing direction the image motif is produced by other sub-regions having another optical depth and is thus perceived in another color.

As mentioned, the security in DOVIDs mainly lies in the advanced and expensive equipment required for production. But, the availability of this equipment inherently spreads and becomes cheaper over time, so that new effects and new technologies must continuously be developed to keep ahead of counterfeiters. This is also the reason why holograms are not so secure anymore, as the production of simple holograms had become almost a standard exercise at graduate school level physics classes. Hence, diffractive grating based security labels which are more difficult to copy would be advantageous, and in particular optical effects which are more difficult to detect and reproduce would be advantageous.

U.S. Pat. No. 6,271,967 referred to above further discloses a way to complicate holographic copying procedures as typically applied by forgers and counterfeiters, where light is diffracted in the element to copy the visible information, see column 4, lines 11-12. This involves relatively displacing the gratings of immediately adjacent sub-regions of a pixel relative to each other by a fraction of the grating period. The relative displacement of immediately adjacent sub-regions within the pixel causes reduction or extinction of the pixel for specific wavelengths typically used in such procedures. Hence, when counterfeiters try to copy the elements using these wavelengths, pixels will change or disappear in the process so that not all information visible under white light will be transferred, see e.g. column 4, line 57-column 5, line 14.

In another patent by the same applicant, U.S. Pat. No. 6,243,202, this technique of intra-pixel grating displacement is used to control the perceived brightness of a pixel. In a pixel with sub-regions whose smallest dimensions cannot be resolved with the naked eye, the light fields emitted by immediately adjacent sub-regions add in the eye of a viewer. Thereby, the brightness of a pixel can be adjusted by way of the relative displacement or shift of the relief structure of adjacent sub-regions in the pixel.

### SUMMARY OF THE INVENTION

It is an object of the invention to provide a method for encoding phase information into DOVIDs that cannot be seen by the naked eye and which complicates copying of the DOVID. It is another object to provide a method for decoding phase information from a DOVID with encoded phase information. It is a further object to provide a DOVID with encoded phase information as well as a reader for reading the phase information from such DOVID.

The above described objects are intended to be obtained in a first aspect of the invention by providing a method for phase-encoding a graphical element invisibly into a DOVID as specified in accompanying claim 1.

In a second aspect, the invention provides a method for de-coding a graphical element that has been phase-encoded invisibly into a DOVID as specified in accompanying claim 9. The method is preferably used to verify the originality or authenticity of the DOVID.

In a third aspect, the invention provides a reader for reading a graphical element that has been phase-encoded invisibly into a DOVID as specified in accompanying claim 11. The reader is preferably used to verify the originality or authenticity of the read DOVID.

In a fourth aspect, the invention provides a DOVID comprising a plurality of periodic micro-grating regions with grating line positions relatively shifted such that a distribution of encoded relative shift values represents a graphical element thereby phase-encoded invisibly into the DOVID as specified in accompanying claim 12.

In a fifth aspect, the invention provides a security kit comprising a DOVID according to the fourth aspect, or a representation thereof (such as a template, a matrix, an electronic file for printing or writing, or similar), and an electronic representation of the known or predetermined graphical element as specified in accompanying claim 14.

In a sixth aspect, the invention provides a computer program for calculating relative shift values for phase-encoding a graphical element invisibly into a DOVID comprising a plurality of pixels, each consisting of a periodic micro-grating region, being addressable by an index (i,j), and having common grating line spacing, L, and grating line orientation, the computer program providing the following when executed by an electronic processor:
given a graphical element to be invisibly encoded in the form of contrast values, Cₖₗ, for sections in the graphical element corresponding to the micro-grating regions, calculating relative shifts of grating line positions in pixels such that the encoded relative shift values, sᵢⱼ, of pixels in the DOVID are a function of the contrast values Cₖₗ of corresponding sections in the graphical element;
determining a possible layout of grating line positions for the pixels.

In a seventh aspect, the invention provides a system for writing a diffractive optically variable identification device (DOVID) with a phase-encoded graphical element, the system comprising:
a computer holding or having access to the computer program according to the sixth aspect and preferably being configured to execute the computer program and provide the layout of grating line positions in a suitable file format; and
means for writing diffractive gratings and being connected to the computer, the means for writing being configured to write diffractive gratings based on at least a received layout of grating line positions.

In the following, a number of further aspects, preferred and/or optional features, elements, examples and implementations will be described. Features or elements described in relation to one embodiment or aspect may be combined with or applied to the other embodiments or aspects where applicable. For example, structural and functional features applied in relation to the DOVID or the reader may also be used as features in relation to the methods for encoding and decoding phase information by proper adaptation and vice versa. Also, explanations of underlying mechanisms of the invention as realized by the inventor are presented for explanatory purposes, and should not be used in ex post facto analysis for deducing the invention.

The overall grating structure of a DOVID can be divided into pixels, where each pixel consist of a periodic micro-grating region, so that each pixel/region can be defined by means of at least its grating line spacing (the distance between the periodic grating lines or profiles, also referred to as its spatial frequency), the grating line orientation (i.e. the common direction along which the grating lines within a single micro-grating are oriented), and the grating relief profile (hereunder the optical depth). The micro-grating regions may be formed as pixels in a grid with the micro-grating regions abutting each other or being separately formed with space without grating structure in between. Alternatively, grating lines of the micro-grating regions are connected to form continuous variations in grating line spacing and orientation. Such need not be restricted to rectilinear gratings, curved profiles and grating structures of a polygon-like configuration (where rectilinear grating lines adjoin each other) can also be used. The micro-grating regions can have any shape (typically circular or rectangular) and be arranged in any pattern (typically in a two-dimensional regular grid) where the micro-grating regions are addressable by index (i,j). References to the micro-grating regions by such index are given both as parenthesis, e.g. s(i,j), and as subscripts, e.g. sᵢⱼ.

The pixels or micro-grating regions will in the following be referred to as pixels, regions or micro-gratings, depending on the context. It is to be understood that these terms can be interchanged in most instances. In the claims, the formulation “pixel consisting of a periodic micro-grating region” is used to specify the commonly used division of DOVIDs into well-defined units of pixels and to specify the grating content in these pixels.

The pixels or micro-grating regions are usually made so that the grating line spacing and orientation of each region are adjusted to be visible at certain intervals of observation orientation and angle. But, the pixels may all have identical grating line spacing and orientation so that the DOVID appears blank or featureless under all orientations and angles (such DOVID may, however, show a rainbow spectrum if the area is big enough). Optically variable effects such as multi-channel image switching and right angle effects can be produced by using adjacent diffractive pixels of different spatial frequency or different grating line orientation or different grating profiles.

The present invention introduces a new, additional micro-grating region parameter, namely the alignment of grating line positions in different pixels of the DOVID having common grating line spacing and grating line orientation.

For purposes of illustration only, a periodic reference-grating covering the DOVID and having the common grating line spacing and grating line orientation is introduced. For practical purposes and referring to FIG. 1, the reference grating can be aligned with the grating lines of pixel A1.

Relative shifts in alignment of grating line positions between micro-grating regions can be introduced by displacing the grating line positions in one pixel (here pixel B1) relative to the reference grating or another pixel (here pixel A1 in both cases) by a distance d_{B1}. The displaced distance d_{B1} defines the shift in pixel B1 in relation to the reference grating or pixel A1.

These shifts in alignment of the grating line positions introduce relative shifts in the phase of light diffracted by the micro-grating regions, so as to introduce a spatial phase shift distribution corresponding to the distribution of grating line position shifts over the DOVID. As such spatial phase shift distribution is not visible to the naked eye, the phase encoding according to the invention provides the major advantage that it is invisible to the naked eye. This means that additional information can be hidden into a DOVID without adversely affecting the visible graphic and dynamic elements that these DOVIDs typically display, typically referred to as the overt features.

Due to the periodicity of the gratings, it follows dᵢⱼ˜dᵢⱼ+NL, where N is an integer. Hence displacements longer than the grating line spacing are generally not relevant and can be reduced to a net-displacement smaller than the grating line spacing L so that the shift essentially becomes a periodic function. It is practical to quantify the shift by the relative shift value sᵢⱼ defined as the ratio between the displacement distance and the common grating line spacing L, generalized as:

sᵢⱼ=dᵢⱼ/L|ε[0;L]. (1)

A few notes regarding reference grating and the inherent periodicity is given in the following.
In the example illustrated in FIG. 1, the shift is defined relative to the grating line positions of the reference-grating which is aligned with pixel A1. However, the relative shift of grating line positions in all pixels may be quantified relative to any one selected pixel and/or relative to an initial alignment of grating line positions in all pixels, so that this one selected pixel or this initial alignment represents the common reference-grating. Alternatively or additionally, a reference-grating may be defined whose grating lines may not align with the grating lines of any pixels, and relative shifts may be quantified in relation thereto. A common reference grating need not be something physical, but is the precise control of relative grating line positions of micro-grating regions of pixels that are physically separated. The possibility of utilizing a common reference grating depends in the first instance on the technique and the equipment used to on fabricate the DOVID. Then, in the second instance, it depends on designing the DOVID so that the gratings to be written with the technique and the equipment applies the possibility of controlling relative grating line positions between different parts of the DOVID to incorporate phase encoded graphical elements. For all cases, the shifts of the grating line positions of the pixels used to encode a graphical element should be quantified relative to the same reference grating. The reference grating is preferably the same for all pixels used to encode phase information in the entire DOVID. However, in some situations, such common reference may be hard to achieve over the entire DOVID. Therefore, it is also possible to define independent domains, consisting of a group of pixels in the DOVID, where the shifts of gratings in a domain are quantified relative to the same reference grating, which need not be the same as the reference grating in other domains. In a preferred embodiment, a domain comprises at least two pixels having the common grating line spacing orientation, and which are not connected via other pixels having the common grating line spacing and orientation.
Due to the periodicity of the gratings, the relative shift value sᵢⱼ is a periodic function of the displacement so that sᵢⱼ (dᵢⱼ)=sᵢⱼ (dᵢⱼ+NL), where N is an integer.
Several other parameterizations of a relative shift value sᵢⱼ than the ratio defined in Eq. (1) are possible, such as e.g. sᵢⱼ=sin(2ndᵢⱼ/L) or sᵢⱼ=exp(i2ndᵢⱼ/L).
The direction of the displacement (left-right in FIG. 1) is not important as long as the displacement is consistently measured in the same direction for all pixels or calibrated as d′ᵢⱼ=L−dᵢⱼ when measured in an opposite direction.

As mentioned, the relative shifts in grating line positions between micro-grating regions introduce relative shifts in the phase of light diffracted by the micro-grating regions. Thereby, a spatial phase distribution q in the diffracted light corresponds to the induced distribution of shifts sᵢⱼ in the grating line positions of the micro-grating regions:

φᵢⱼ=2πsᵢⱼ. (2)

The graphical element may be any one- or two-dimensional graphical representation such as text, graphics, images, photographs, patterns, machine-readable representations such as linear (1D) and matrix (2D) barcodes, randomized patterns, as well as any combinations of such.

The distribution of encoded relative shift values, sᵢⱼ, represents (or corresponds to or is equivalent to) the graphical element. This is to be understood so that when a spatial phase distribution of spatially coherent light diffracted by the micro-grating regions having the distribution of encoded relative shift values, sᵢⱼ, is detected or converted into a visible intensity distribution, the graphical element will re-appear.

The graphical element can be provided as a visible version in the form of contrast values, Cₖₗ, for sections in the graphical element addressable by an index (k,l). The index (k,l) of the sections may identical to the index (i,j) of the micro-grating regions, in which case each contrast value Cᵢⱼ will correspond to a relative shift value sᵢⱼ. Alternatively, the indices may be different in which case going from the contrast values of the sections to the relative shift values of the micro-grating regions will involve over- or under-sampling. The contrast values Cₖₗ may refer to colour contrast, brightness contrast, intensity contrast, such as typically greyscale or black & white. Thus, the contrast values may be numbers in a range, percentages or ratios, colours or tones, etc.

It is noted, that what is disclosed in the prior art, specifically in U.S. Pat. No. 6,243,202, is intra-pixel displacement in the grating period of sub-regions of a pixel, where sub-regions are relatively displaced with regard to immediately adjacent sub-regions within the pixel. The effect of this displacement is to control the perceived brightness since the wave fields emitted by the adjacent sub-regions add in the eye of the viewer. In this case the object of displacement is to control the display of overt information.

On the contrary, the object of displacement in the present invention is to embed covert information without affecting, and instead preserving, the overt features desired in DOVIDs. The effect of the displacement in the present invention is to encode invisible phase information into a DOVID using pixels distributed over the entire DOVID or in selected domains. The overt DOVID features can be checked by the naked eye, as a usual first line of authentication and the encoded invisible phase information can be viewed by machine reader, a phase imaging system. This is inter-pixel displacement and requires that all pixels used to encode information are displaced relative to a common reference grating defined for the entire DOVID or for the selected domains.

According to a preferred embodiment of the invention, the relative shifts of grating line positions are induced such that the encoded relative shift values, sᵢⱼ, of micro-grating regions in the DOVID are a function of, such as preferably proportional to, the contrast values Cₖₗ of corresponding sections in the graphical element. In an example where indices (i,j) and (k,l) are identical, the function may be a proportionality such as sᵢⱼ=k Cᵢⱼ, where k is any constant. In an example where indices (i,j) and (k,l) are different, the function may involve sampling such as sᵢⱼ=k (C_{i,2j-1}+C_{i,2j})/2.

Phase encoding may be performed in several different channels on the same DOVID, so that each channel contains a different graphical element. In a preferred embodiment, this is implemented using different sets of micro-gratings, with micro-gratings in each set having the same grating line spacing and grating line orientation, but with different sets having different grating line spacing and/or grating line orientation. Thereby, the information phase encoded in each channel (one channel corresponding to one set of micro-gratings) can be read separately under different angles or orientations of the DOVID. The different sets of micro-gratings also results in visual effects (visible graphical elements) in the DOVID that are typically different from the phase encoded graphical elements (but may be made identical to if desired). Thus, the DOVID may contain visibly encoded information (gratings with different line spacing, orientation, profile etc.) which is overlaid with invisible phase encoding containing different information.

In a preferred embodiment, the phase encoded information is also phase encryptied, in that an additional relative shifts are induced by adding phase-encrypting shift values s_{c,ij} to the relative shift values prior to encoding in the DOVID. For practical purposes, a formalism related to the embodiment involving contrast value representation (Cᵢⱼ) of the graphical element is adopted, and the encoded (i.e. written) relative shift values can be expressed as:

sᵢⱼ=f(Cᵢⱼ)+s_{c,ij}=s′ᵢⱼ+s_{c,ij}, (3)

where f(Cᵢⱼ) or s′ᵢⱼ is the, now intermediate, relative shift distribution representing the graphical element. The resulting spatial phase distribution in spatially coherent light diffracted by the DOVID can be expressed as:

φᵢⱼ=φ′ᵢⱼ+φ_{c,ij}, (4)

where φ′ᵢⱼ is the component from the graphical element and φ_{c,ij} is the component from encryption which equals 2πs_{c·ij}.

After the usual visual inspection of the DOVID's overt features, a second level verification of the DOVID's authenticity involves two steps. A first phase-decryption step where the phase encryption component φ_{c,ij} of the spatial phase distribution φᵢⱼ is removed, and a second phase-decoding step where the remaining phase distribution is detected or converted into a visible intensity distribution so that the graphical element re-appears. The decryption preferably involves inducing, in electromagnetic radiation diffracted by the DOVID, a decrypting phase shift distribution, φ_{d,ij}, corresponding to the phase-phase-encrypting shift values s_{c,ij}.

φ_{d,ij}=−2πs_{c·ij}=−φ_{c,ij} (5)

The decrypting phase shift distribution, _{d,ij}, may be induced by a phase-decryption key, the possession of which is thereby required in order to verify the authenticity of the DOVID. This may be performed by directing light to be diffracted by, or light already diffracted by, the DOVID through a phase mask encoded with phasor values e^{-iφd(i,j)}, or, alternatively, by diffracting the light in an array of micro-grating regions encoded with a relative shift distribution s_{d,ij}:

s_{d,ij}=φ_{d,ij}/2π=−s_{c·ij}. (6)

Hence, it does not matter whether the decrypting phase shift distribution is introduced before or after diffraction in the DOVID as phase shifts are additive.

It may also be preferred to use electronic decryption of the phase-encrypted information. Here, the phase-encoded, phase-encrypted information is converted to an intensity distribution without adding the decrypting phase shift values, i.e. without using a phase-decryption key, and where the decryption is subsequently performed via electronic post processing of the read intensity distribution using an electronic phase-decryption key.

In summary, the invention relates to encoding phase information in micro-grating-based anti-counterfeit devices such as DOVIDs. The invention utilizes that alignment of grating line positions in different micro-gratings with common line spacing and orientation, can be used as a new, additional information channel in DOVIDs. By displacing grating lines between micro-gratings, relative shifts in alignment are introduced that do not affect the visual effects encoded in the DOVID. The relative shifts in line position alignment induce relative shifts in the phase of light diffracted by the DOVID, so as to introduce a spatial phase shift distribution corresponding to the distribution of grating line position shifts over the DOVID. Such spatial phase shift distribution is not visible, and the phase encoded information is thereby invisible unless a reader based on e.g. generalized phase contrast is applied. The phase encoded information can further be phase encrypted so that a spatial phase modulator decryption key is required to read the encoded information.

The individual aspects of the present invention may each be combined with any of the other aspects. These and other aspects of the invention will be apparent from the following description with reference to the described embodiments.

### BRIEF DESCRIPTION OF THE FIGURES

The invention will now be described in more detail with regard to the accompanying figures. The figures show one way of implementing the present invention and is not to be construed as being limiting to other possible embodiments falling within the scope of the attached claim set.

FIG. 1 illustrates a relative shift of grating line positions between micro-grating regions, and illustrates both the relative displacement, dᵢⱼ, and the relative shift value, sᵢⱼ.

FIG. 2 illustrates a graphical element divided into sections having contrast values, Cₖₗ.

FIG. 3 illustrates a DOVID divided into micro-grating regions having relative shift values, sᵢⱼ.

FIGS. 4-7 illustrate different examples of phase encoded DOVIDs and the corresponding graphical elements with grey-scale contrast values.

FIG. 8 is a flow chart illustrating the procedure of reading DOVIDs with encoded phase information.

FIGS. 9-14 illustrate different embodiments of a reader for reading DOVIDs with encoded phase information.

### DETAILED DESCRIPTION OF AN EMBODIMENT

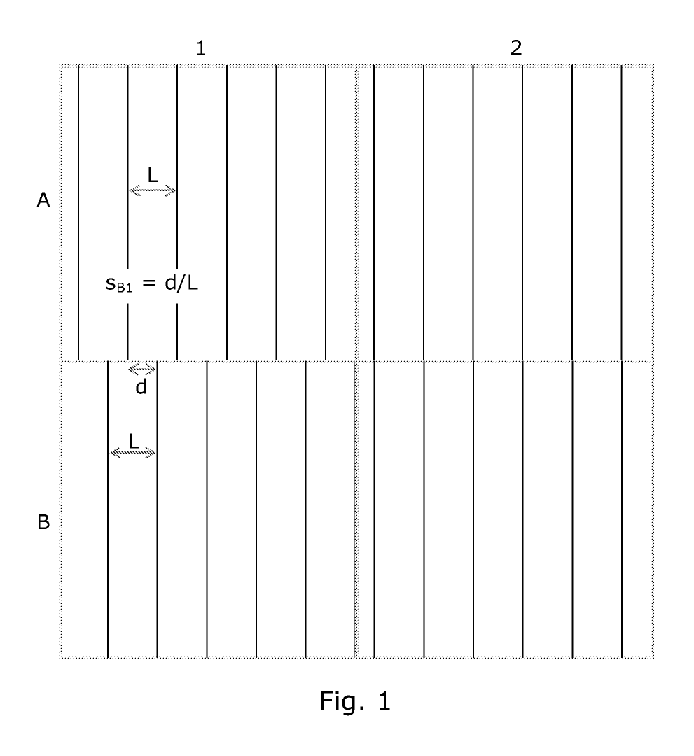

FIG. 1 is an example illustrating the relative shift of grating line positions between micro-grating regions A1 and B1, and illustrates both the relative displacement, dᵢⱼ, and the relative shift value, sᵢⱼ. In the example illustrated in FIG. 1, the shift is defined relative to the grating line positions of the reference-grating which is in this example aligned with region A1.

In the following, a number of embodiments illustrating some of the possibilities for phase encoding information in DOVIDs will be described. For this purpose, exemplary graphical elements described by contrast value distributions Cᵢⱼ are used to generate DOVIDs characterized by corresponding relative shift value sᵢⱼ distributions resulting in, when read, a corresponding spatial intensity value distribution, Iᵢⱼ.

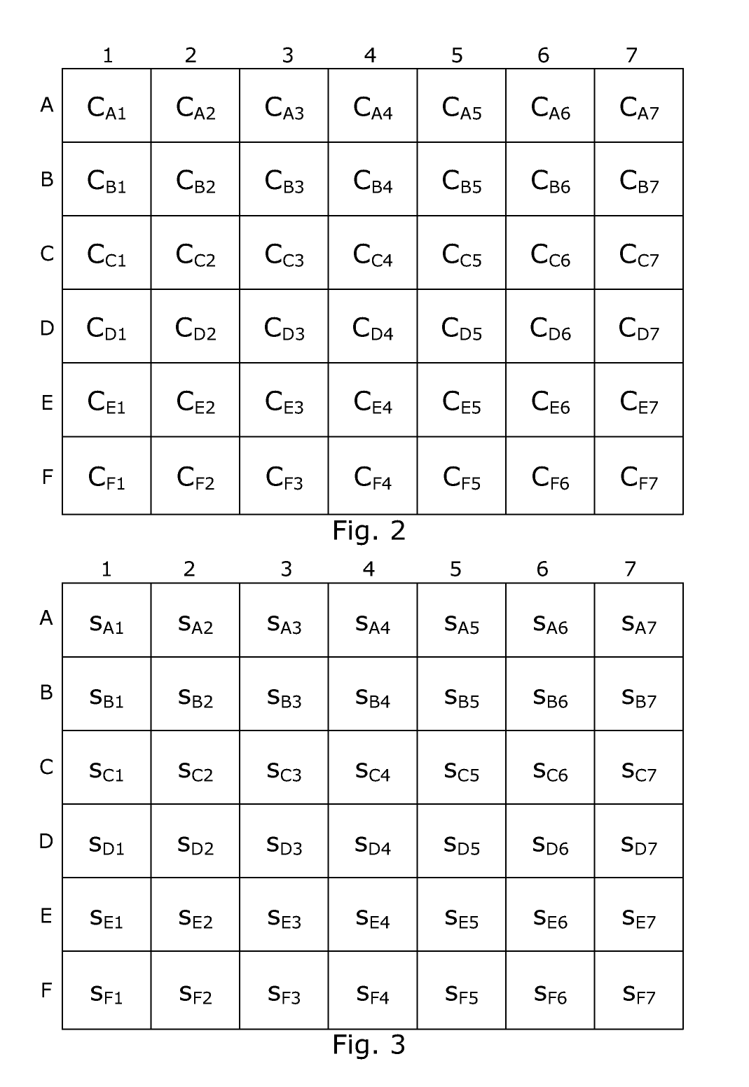

FIG. 2 illustrates how any one- or two-dimensional graphical element can be divided into sections having contrast values, Cᵢⱼ. Similarly, FIG. 3 illustrates a DOVID divided into micro-grating regions having relative shift values, sᵢⱼ. DOVIDs can be fabricated in different resolutions which continuously increase. For low-resolution DOVIDs of 500 dots/mm, grating lines would be ˜2 micron apart.

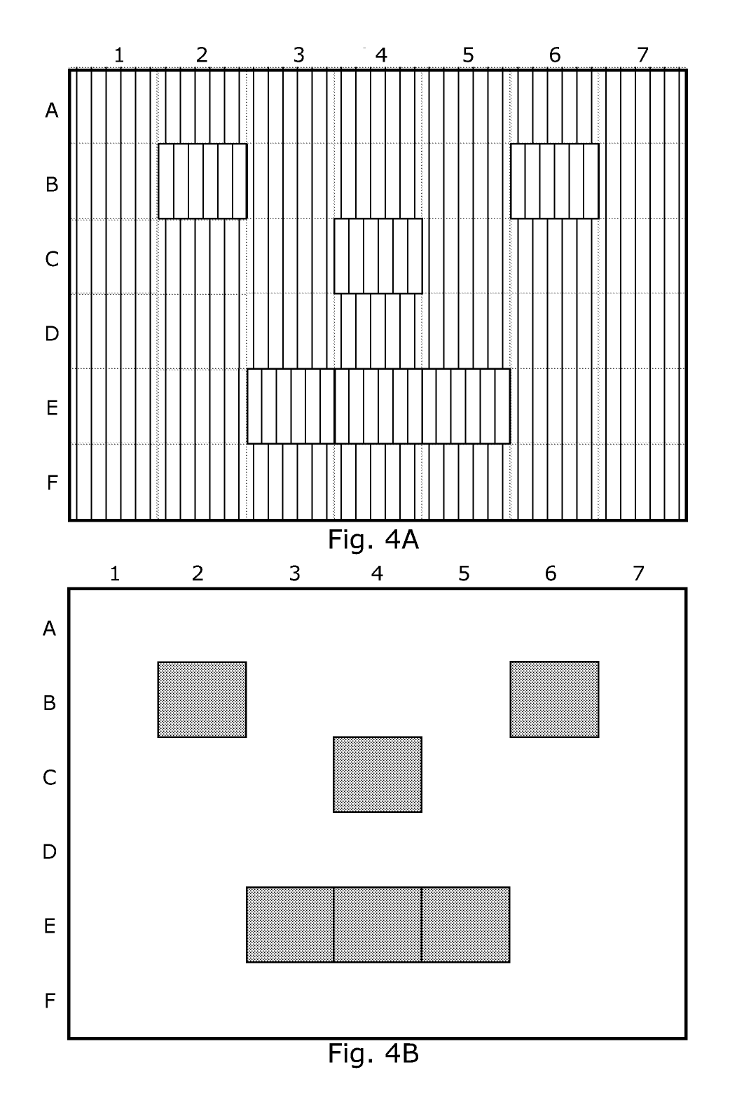

FIGS. 4-7 illustrate different examples of phase encoded DOVIDs, the corresponding graphical elements with grey-scale contrast values and the spatial intensity distributions resulting when reading the DOVID (here identical to the grey-scale contrast value distribution of the graphical element).

FIG. 4A illustrates a DOVID encoded with relative shifts of grating line positions between micro-grating regions having common grating line spacing, L, and grating line orientation. FIG. 4B illustrates the graphical element encoded into the DOVID or, similarly, the spatial intensity distribution resulting from imaging the spatial phase distribution of spatially coherent light diffracted by the DOVID. As all micro-gratings have the same grating line spacing, grating line orientation, and grating relief profile (not visible in FIG. 4A), the DOVID in FIG. 4A would appear blank or featureless to the naked eye.

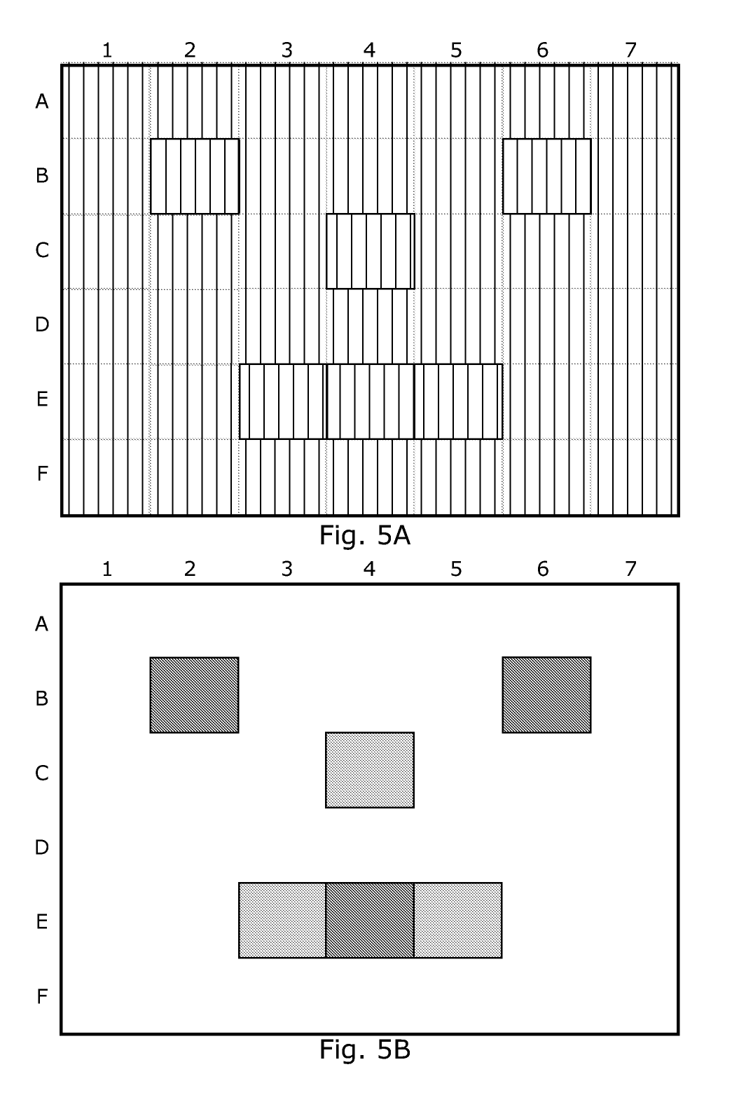

FIG. 5A illustrates a DOVID encoded with relative shifts similarly to FIG. 4A, but where the relative shift value distribution involves three different relative shift values. The corresponding graphical element shown in FIG. 5B thereby also have three different contrast values; C_{A1}=0˜white; C_{B2}=0.25˜light grey; and C_{c4}=0.5˜grey. These contrast values are encoded into the DOVID so that so that s_{A1}≠s_{B2}≠s_{C4}. Thereby, the spatial intensity distribution resulting from the spatial phase distribution of spatially coherent light diffracted by the DOVID also involved three different values. Thereby, this DOVID can be used to illustrate more complex graphical elements that the two-tone or binary shift versions illustrated in FIGS. 4A-B. As all micro-gratings have the same grating line spacing, grating line orientation, and grating relief profile (not visible in FIG. 5A), the DOVID in FIG. 5A would appear blank or featureless to the naked eye.

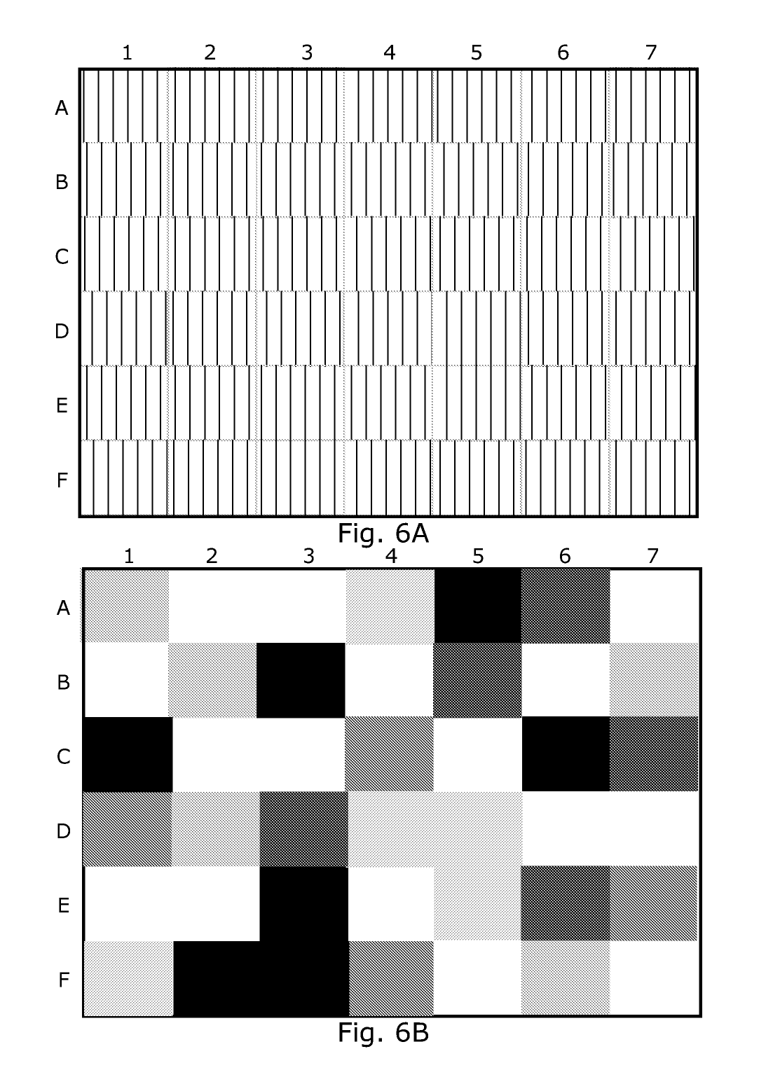

FIGS. 6A and B illustrates (A) a DOVID encoded with relative shifts similarly to FIGS. 4A and 5A, but here using five different relative shift values and (B) the graphical element having five different contrast values encoded into the DOVID, or the spatial intensity distribution resulting from the spatial phase distribution of spatially coherent light diffracted by the DOVID. The graphical element in FIG. 256B is a randomly generated pattern. As all micro-gratings have the same grating line spacing, grating line orientation, and grating relief profile (not visible in FIG. 6A), the DOVID in FIG. 6A would appear blank or featureless to the naked eye.

FIGS. 7A and B illustrates a DOVID with both invisible phase encoded information and visible information—FIG. 7A shows the DOVID of FIG. 6A, but where micro-grating regions having common relative shift value (here sᵢⱼ=0 corresponding to the white regions in FIG. 6B) have been used to encode visible information in by modulating the grating line spacing or the grating line orientation. Equivalently, the grating line profile could also have been modulated. The micro-grating regions with phase-encoded information are given a grey-tone in FIG. 7A to help guide the eye to the micro-gratings with visible encoding.

The spatial intensity distribution resulting from the spatial phase distribution of light diffracted by the DOVID would be unaffected and still look like FIG. 6B, but to the line spacing or orientation modulation would result in the visual patterning of the DOVID shown in FIG. 7B (depending on the orientation and angle of observation) so that the DOVID would not appear blank or featureless to the naked eye. The phase-encoded micro-grating regions are shown with a grey-tone in FIG. 7B, but their actual colour is not important, only the fact that they will appear identical to the naked eye. The phase-encoded micro-grating regions in FIG. 7B show a meaningless grey-tone pattern, but they may be arranged to depict a meaningful visual pattern, e.g. shapes, text, etc., as desired. As mentioned several times, the grating lines drawn in FIGS. 4A-7A can also have defined shapes examined on side view. For example, instead of just simple square wave profiles, they can be saw tooth/blazed gratings, triangular, sine wave, etc. as well as varying heights to control how much light is scattered in different directions. This is described in e.g. U.S. Pat. No. 6,975,438 where a triangle slope is varied to create a new information channel.

The DOVIDs shown in FIGS. 4A, 5A, 6A, and 7A embody different DOVIDs with encoded phase information in the form of relative shift value distributions sᵢⱼ. The encoded relative shift values, sᵢⱼ, are a function of the contrast values Cₖₗ of the corresponding graphical elements of FIGS. 4B, 5B, 6B, and 7B. The DOVIDs are typically formed on a product or a document, or on a label to be placed on or accommodate such, in order for another party to verify the originality or authenticity of the product or document. In order to do that, the other party must have knowledge of the graphical element supposed to be encoded in the relative shift values. Therefore, a DOVID with a phase encoded graphical element and an electronic representation of the graphical element form a security kit in accordance with the fifth aspect of the invention.

The security kit comprising the DOVID or a representation thereof (such as a template, a matrix, an electronic file for printing or writing, or similar) and the electronic can be distributed to producers or manufacturers of the products or documents that are to security labelled. But, the product or document with the DOVID and the electronic representation are typically not distributed together. The product or document with the DOVID are typically freely distributed or sold, whereas the electronic representation of the graphical element are only distributed to selected clients, institutions or authorities who have the role of verifying the originality of the product or document. It would also be possible to have on-the-fly key retrieval from a central repository during the verification stage

As described previously, the DOVID may contain phase encoding in several different channels, using several different sets of micro-gratings. Starting from the above description of FIG. 7A, it is relatively straightforward to see how other sets of pixels can also be phase encoded. In FIG. 7A, the following three sets: [A2, A3, B6, E1, E2, F7], [A7, B1, B4, C2, E4], and [C3, C5, D6, D7, F5] each consist of micro gratings having the same grating line spacing and grating line orientation, but have mutually different grating line spacing and/or grating line orientation (that are also different from the already phase encoded set marked up with grey in FIG. 7A). Each of these sets may be phase encoded by introducing relative shifts in the grating line positions of the micro-gratings, and the DOVID in FIG. 7A thus provides four separate phase encoding channels. It is important to realise that phase encoding of these sets will not affect the visible appearance of the DOVID illustrated in FIG. 7B. Thus, any visible effects of the DOVID will not be affected by the phase encoding.

### Generating Phase Encoded DOVIDs

Generation of a phase encoded DOVID preferably starts with selecting or generating a predetermined/known graphical element which is to be phase encoded. The graphical element is divided into sections corresponding to the micro-grating regions of the DOVID and should be expressed in a one-parameter colour space, so that it can be represented by a contrast value distribution Cᵢⱼ.

The relative shift value to be encoded into each micro-grating region can then be calculated from the contrast values according to a function sᵢⱼ=f(Cᵢⱼ). In a simplest embodiment, the relative shift values are proportional to the contrast values so that sᵢⱼ=k Cᵢⱼ. In another simple embodiment, the relative shift values are calculated as

$${s}_{ij} = \frac{1}{π} {sin}^{- 1} \sqrt{\frac{{c}_{ij}}{{c}_{max}}} ,$$

to obtain a spatial intensity distribution Iᵢⱼ is identical to Cᵢⱼ (when both are normalized), when read using Generalized Phase Contrast (GPC).

The calculated relative shift value distribution is then used to control the grating line positions for each grating-region in the production (printing or writing) process, e.g. incorporated in the prepress set-up. How this is done in more detail depends on the specific printing or writing process used.

In the embodiments involving phase encryption, the relative shift value distribution to be produced is phase encrypted prior to production. This is done by adding phase-phase-encrypting shift values s_{c,ij} to the relative shift values calculated from the graphical element so that the final phase encrypted, relative shift value distribution to be produced as in Eq. 3:

sᵢⱼ=f(Cᵢⱼ)+s_{c,ij}, (3)

The phase-phase-encrypting shift value distribution, s_{c,ij}, may be randomly generated, preferably using a predefined set of possible s_{c,ij} values taking the precision of the production method into consideration. Alternatively, s_{c,ij} may be generated using an encryption algorithm or parameter that can be shared without sharing the actual distribution s_{c,ij}.

In most previous DOVID fabrication techniques, not particular attention has been paid to aligning the grating line positions between micro-gratings. Therefore, some DOVID fabrication techniques may require adaptation to make it possible to control grating line positions between micro-gratings with the precision required for phase encoding. The precision required for aligning grating lines of different micro-gratings to implement phase encoding depends on the grating line spacing L as well on how many different relative shift values is to be used. For a black/white graphical element only two relative shift values are used, and using proper rounding of the read intensity values, a fairly low precision such as ±0.2dᵢⱼ in the grating line positions might be acceptable. On the other hand, a graphical element with e.g. ten different grey-tone values will require a precision better than ±0.05dᵢⱼ. As it may be challenging to maintain a uniform alignment precision of the grating line positions over a wide area, it can be advantageous to, for the purpose of fabricating a master, divide the DOVID into multiple smaller subzones/subregions within which the alignment precision can be maintained.

By including the grating line displacements during the mastering stage, which can be done using e-beam or lasers, the micro-grating line position shifts can be reproduced during the mass-replication, whether using foil-based technologies, or foil-free technologies like Holoprint. A number of applicable mastering systems exist, such as Lightgate® (www.sitech.co.uk/sitech_{—}004.htm), Kinemax® (www.kinemax.pl/mastering.html). References to other applicable mastering systems may be found here: www.pizzanelli.co.uk/DIGITAL/digital.html.

In principle, normal DOVIDs which are generated without the intention of phase-encoding may also contain accidental and thereby unknown phase-encoding. This occurs since, as already mentioned, most present techniques for forming DOVIDs are not careful in aligning the grating line positions between micro-grating regions. This lack of attention to alignment of grating line positions is due to that mis-alignments do not result in any visible deterioration of the DOVID (which is exactly the effect utilised in the invisible phase-encoding of the invention).

This un-intentional or accidental, unknown phase encoding is typically randomized, but may also be regular or systematic according to the functioning of the apparatus used to form the micro-grating regions. It is, however, essential that for prior art DOVIDs containing such accidental phase-encoding, there exist no pre-determined or known graphical element that the manufacturer of the DOVID could use to verify the identity or originality or authenticity of the DOVID by means of detecting the phase-encoded information.

In an embodiment of the present invention, un-intentional and thereby unknown phase-encoding in DOVIDs are detected by detecting a spatial intensity distribution generated from the spatial phase distribution induced in light diffracted by the DOVID. The detected spatial intensity distribution can be converted to a graphical element, which can then, later be used to confirm the originality of the DOVID as for the DOVID with intentionally phase-encoded known graphical elements.

### Reading Phase-Encoded DOVIDs

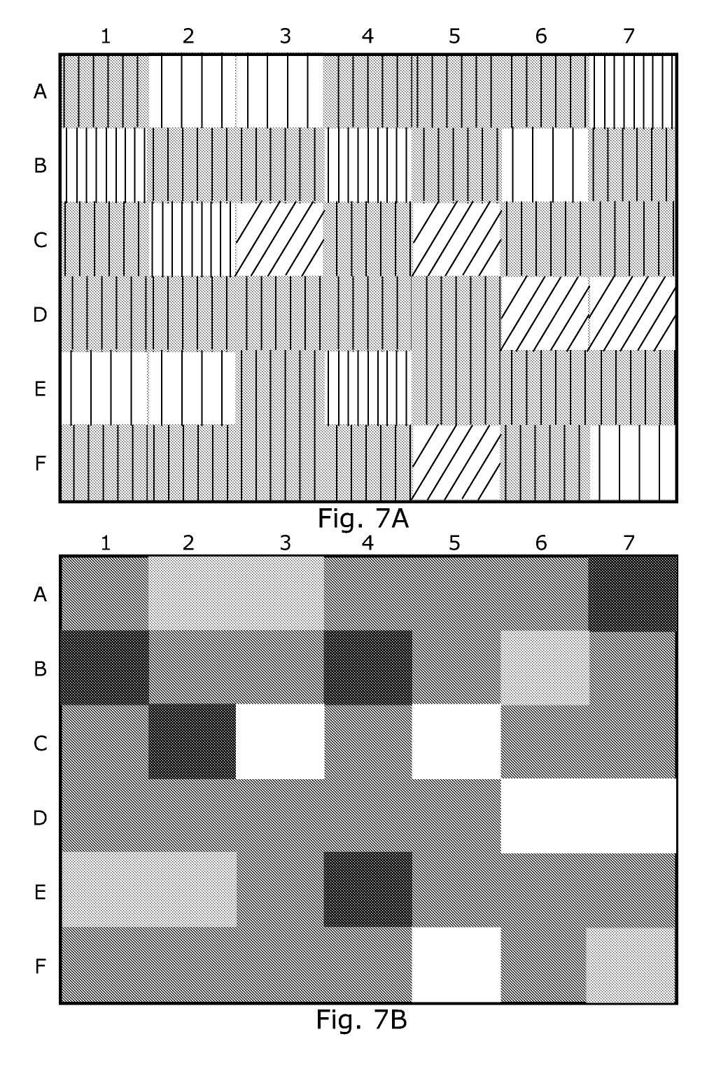

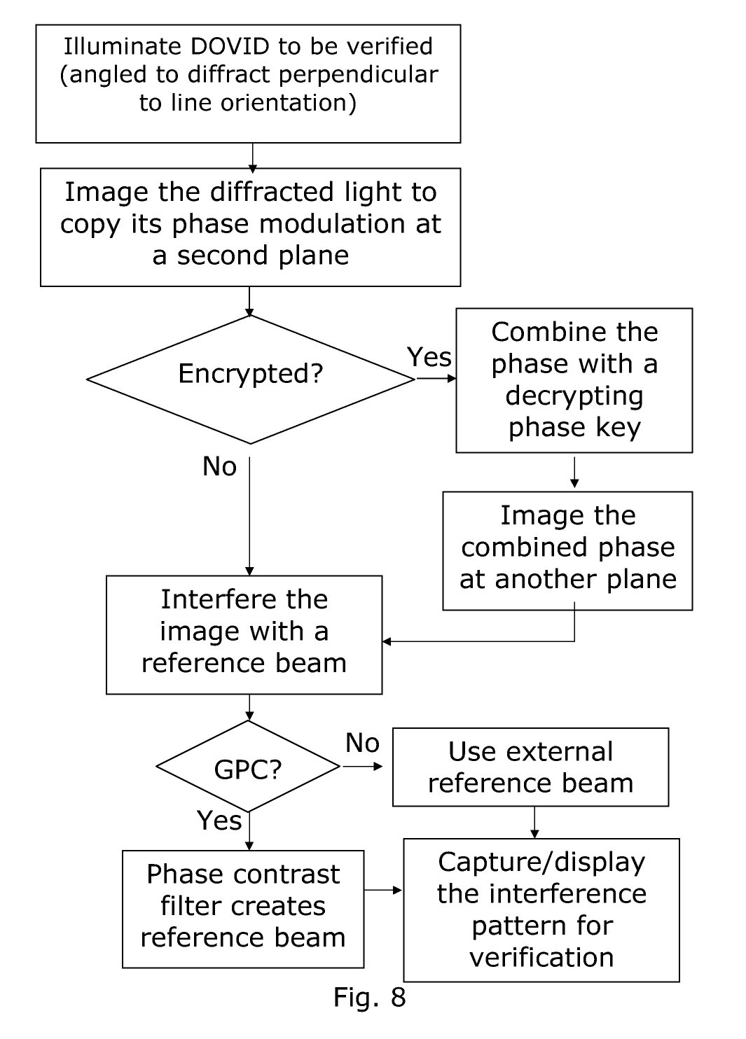

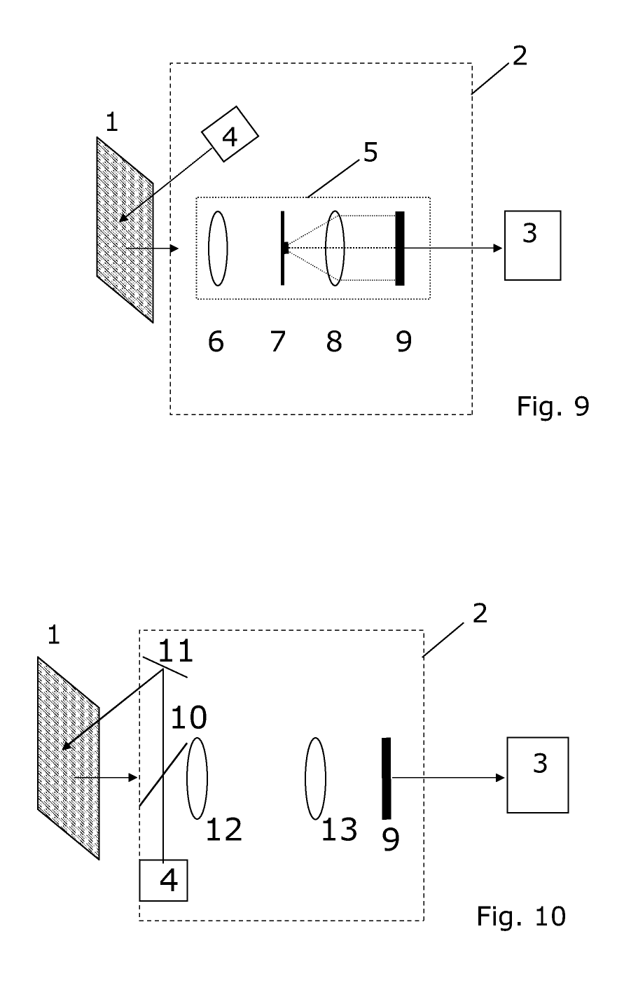

The flow chart in FIG. 8 illustrates the procedure for reading phase-encoded information in DOVIDs. FIGS. 9-14 illustrates set-ups according to different embodiments of the reader. FIGS. 9-14 all illustrate a DOVID 1 with phase encoding, a reader 2, and a display 3 such as a camera display or a computer monitor, which may be integrated into the reader. All readers 2 involves a laser or another coherent light source 4, whereas the remaining components depends on the specific set-up. The read procedure outlined in FIG. 8 will now be described with reference to the reader set-ups illustrated in FIGS. 9-14.

First, the DOVID 1 to be verified is illuminated by the laser 4 angled to diffract perpendicular to line orientation. The diffracted light will contain the spatial phase distribution φᵢⱼ corresponding to the relative shift distribution sᵢⱼ of the grating line positions between the micro-gratings. The diffracted light is imaged to reproduce the spatial phase distribution q at an output plane, and (taking for now the path of in FIG. 8 without encryption) the reproduced image at the output plane is interfered with a reference beam to convert the spatial phase distribution into a spatial intensity distribution via constructive/destructive interference in the various regions of the image.

FIGS. 9 and 10 illustrate readers for DOVIDs where the encoded phase information is not also encrypted. FIG. 9 shows an embodiment of a reader based on a generalized phase contrast (GPC) set-up, whereas FIG. 10 shows an embodiment of a reader based on a non-GPC interferometer.

In FIG. 9, the diffracted light is imaged by a GPC set-up 5 comprising a lens 6, a phase contrast filter 7, and another lens 8 in a so called 4f set-up, as well as a camera 9 used to detect the generated spatial intensity distribution. In this set-up, the phase contrast filter 7 provides the phase shifted reference beam while also transmitting information to reproduce the spatial phase distribution on the camera plane. The 4f GPC set-up thus simultaneously performs the phase decoding (conversion of phase shift into intensity difference) and the imaging onto the camera 9.

In FIG. 10, the laser is first sent through a beam splitter 10 to generate the reference beam and thereby to the DOVID via mirror 11. The diffracted light is then imaged by lenses 12 and 13 in spatial overlap with the reference beam. The interferometer shown in FIG. 10 is just one out of many well-known interferometer set-ups for making the spatial phase distribution from the diffracted light visible.

In both FIGS. 9 and 10, the interference results in a spatial intensity distribution corresponding to the spatial phase distribution of the diffracted light, which can be detected by the camera 9 such as a CCD or any other spatial light detector.

As explained previously, the encoded phase information may be phase encrypted, in which case the path with encryption in FIG. 8 is followed. If a DOVID with phase encrypted phase encoded information is preferably read with the reader of FIG. 9 or 10, the resulting intensity distribution will correspond simply to the relative shift values sᵢⱼ as written in the DOVID (see Eq. 3).

In case of phase encryption, the resulting spatial phase distribution in light diffracted by the DOVID is the sum of the component (φ′ᵢⱼ) from the graphical element and the component from phase encryption (φ_{c,ij}). In order to determine whether the DOVID is original, the contribution from encryption is removed before the phase distribution is interfered to convert it into an intensity distribution.

In preferred embodiments of the reader configured to read phase encoded, phase encrypted DOVIDs, a phase decryption involving inducing a decrypting phase shift in the light diffracted by the DOVID is included. The decrypting phase shift distribution, φ_{d,ij}, corresponds to the phase-encrypting shift values s_{c,ij} given previously (Eq. 5), and can be distributed encoded in a physical key in the form of a spatial phase modulator (e.g. a phase mask or a separate DOVID), electronically in the form of the distribution to be encoded in phase mask by the institution performing the verification, or as an algorithm or parameter by which the distribution can be generated.

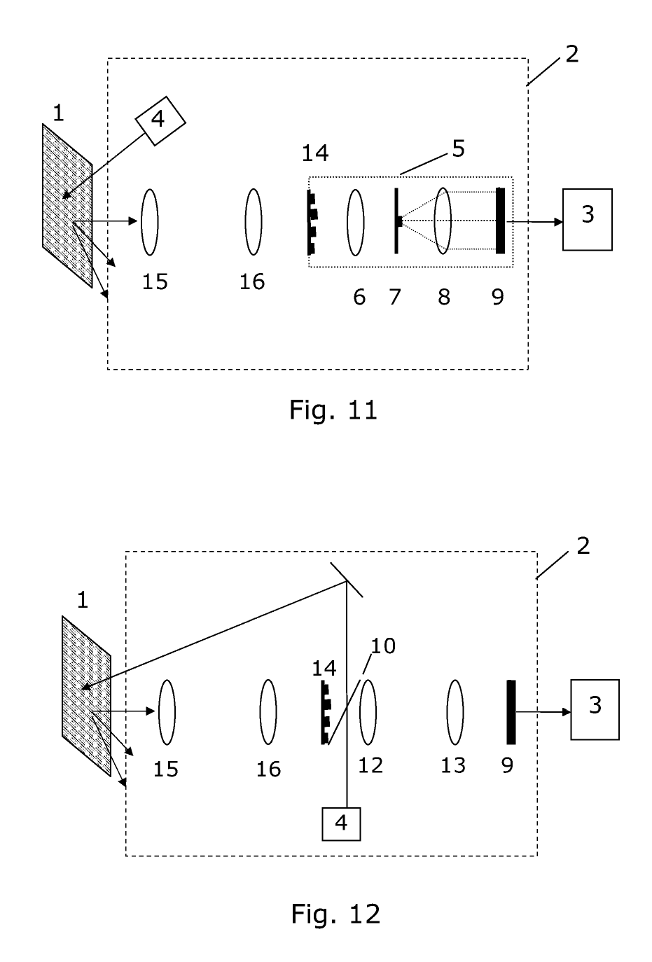

The decrypting phase shift can be induced using either a transmitting or a reflecting spatial phase modulator, and these options are described in the following for both GPC and non-GPC interferometers with reference to FIGS. 11-14. It is noted that the decrypting phase shift can be induced in the light either before or after the diffraction in the DOVID, as phase delays in light are additive. Only the configuration where the decrypting phase shift is induced after the diffraction in the DOVID (by inclusion of a spatial phase modulator holding the decryption key) is shown. If the decryption key, i.e. the spatial phase modulator inducing the decrypting phase shift distribution, is not used, the read spatial intensity distribution will just look like the encrypted graphical element. Inserting the decryption key in the reader produces a spatial intensity distribution looking like the original graphical element. Thus, these setups will decode an unencrypted, phase-encoded DOVID when the decrypting phase shift distribution is not used, i.e. when the spatial phase modulator holding the decryption key is omitted or replaced by a mirror.

FIGS. 11 and 12 illustrate readers for DOVIDs where the encoded phase information is also phase encrypted, and where the reader therefore involves a transmitting spatial phase modulator for inducing the decrypting phase shift distribution. FIG. 11 shows an embodiment of a reader based on a generalized phase contrast (GPC) set-up corresponding to FIG. 9. FIG. 12 shows an embodiment of a reader based on a non-GPC interferometer corresponding to FIG. 10.

In FIG. 11, the light diffracted from the DOVID is imaged onto the transmitting spatial phase modulator 14 by a lens pair 15 and 16. The transmitted light, which now only contains the phase distribution component (φ′ᵢⱼ) from the graphical element, is phase decoded onto a camera 9 by a GPC 4f set-up as described in relation to FIG. 9.

The reader embodied in FIG. 12 images the light diffracted from the DOVID onto the transmitting spatial phase modulator 14 by a first lens pair 15 and 16, similar to in FIG. 11. The light transmitted from modulator 14 is then imaged by lens pair 12 and 13 in spatial overlap with the reference beam from beam splitter 10. As for FIG. 10, the interferometer shown in FIG. 12 is just one out of many well-known interferometer set-ups for making the spatial phase distribution from the diffracted light visible.

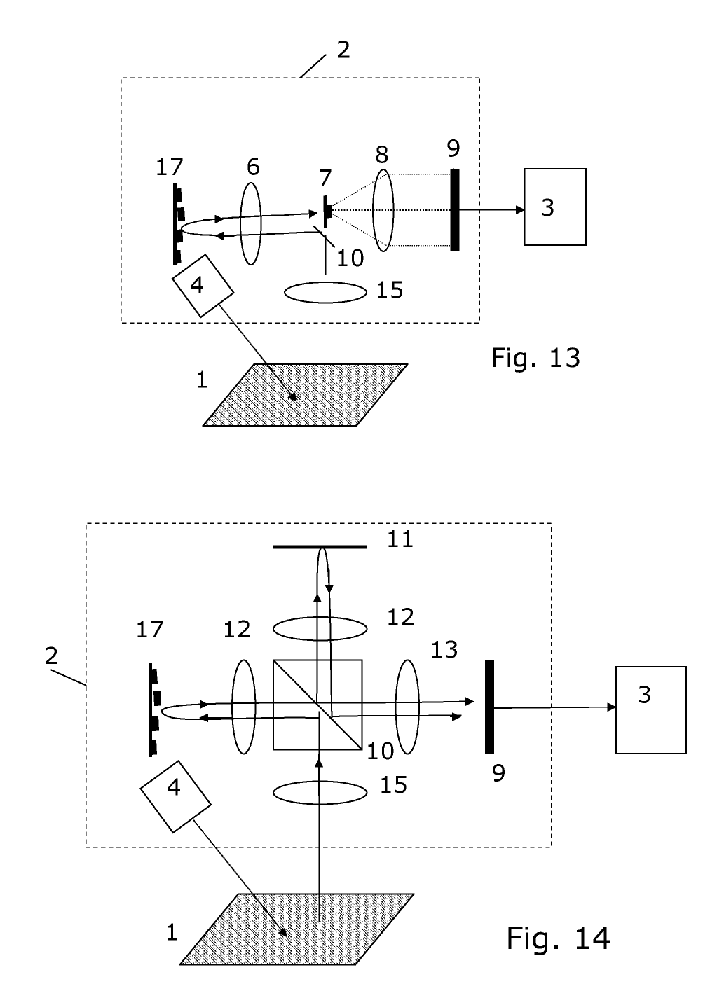

Transmitting spatial phase modulators used as phase-decrypting keys are typically phase masks, which may be fabricated onto transparent plates, e.g. by photolithography/etching techniques. These phase masks may be replaced for verifying other DOVIDs. Another example is another phase encoded transmitting DOVID with relative shift value distribution sᵢⱼ corresponding to the decrypting phase shift distributions φ_{d,ij}. For better flexibility, the spatial phase modulators can potentially be electronically addressable LCD microdisplays capable of being programmed with different decrypting phase shift distributions φ_{d,ij} without moving/replacing the components. Working like LCD monitors, displaying a picture of the decrypting phase mask onto so-called phase-only LCDs creates an invisible phase picture that induces the decrypting phase shift distribution. This involves the advantage that an phase-decryption key (i.e. an electronic decrypting phase shift distribution φ_{d,ij}) can be downloaded and applied on the fly. FIGS. 13 and 14 illustrate readers for DOVIDs where the encoded phase information is also phase encrypted, but where the decrypting phase shift is induced by a reflecting spatial phase modulator. FIG. 13 shows an embodiment of a reader based on a generalized phase contrast (GPC) set-up corresponding to FIGS. 9 and 11. FIG. 14 shows an embodiment of a reader based on a non-GPC interferometer corresponding to FIGS. 10 and 12.

In FIG. 13, the light diffracted from the DOVID is imaged onto the reflecting spatial phase modulator 17 by lens pair 15 and 6. The light reflected from modulator 17, which now only contains the phase distribution component (φ′ᵢⱼ) from the graphical element, is then phase decoded onto a camera 9 by a GPC 4f set-up as described in relation to FIG. 9.

The reader embodied in FIG. 12 images the light diffracted from the DOVID onto the reflecting spatial phase modulator 17 by a first lens pair 15 and 12. The light reflected from modulator 17 is then imaged by lens pair 12 and 13 in spatial overlap with the reference beam from beam splitter 10. As for FIG. 10, the interferometer shown in FIG. 14 is just one out of many well-known interferometer set-ups for making the spatial phase distribution from the diffracted light visible.

Reflecting spatial phase modulators used for phase decrypting can for example be transmitting phase mask with a reflective backside and programmed with (as light passes twice). Another example is another phase encoded DOVID with relative shift value distribution sᵢⱼ corresponding to the decrypting phase shift distributions, φ_{d,ij}. In yet another example, the DOVID 1 may itself contain the decrypting phase shift distribution, as this may be phase encoded into set of micro-gratings with different grating line spacing or grating line orientation than the set used for the primary phase encoding. It is also possible to define different regions/zones for micro-gratings having the same line spacing or grating line orientation such that one zone/region contains the primary encrypted phase and another zone contains the decrypting phase shift. Such use of several phase encoding channels is described in detail previously. The reading, inclusive phase decryption, would then involve diffracting the light from the laser in the DOVID twice under different angles or orientations. In order to induce two different phase shifts into the same transverse parts of the beam, the two channels (and thus the position where the light strikes at the two diffractions) would have to be displaced in relation to each other or have a pattern with a degree of rotational symmetry.

As mentioned previously, it is also possible to use electronic decryption of the phase-encrypted information. Using a reader without a phase-decryption key to read a phase-encrypted DOVID results in an intensity distribution which is still phase-encrypted and the read image can thereby not be used to verify the authenticity of the DOVID. By using an electronic phase-decryption key, e.g. an intensity or contrast distribution corresponding to decrypting phase shift distribution which can simply be added to the read image, the decryption can subsequently be performed via electronic post-processing of the read image.

It is thus to be understood that the phase-decryption key can take many forms, such as a phase mask or a DOVID, an electronic decrypting phase shift distribution which can be programmed into a spatial phase modulator, or an electronic phase-decryption key to be used in a post-processing decryption of a read image.

The individual elements of an embodiment of the reader according to an embodiment of the invention may be physically, functionally and logically implemented in any suitable way such as in a single unit, in a plurality of units or as part of separate functional units. The reader may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

### REFERENCES

U.S. Pat. No. 4,918,469
U.S. Pat. No. 4,629,282
U.S. Pat. No. 6,271,967
U.S. Pat. No. 6,243,202

1. A method for displacing gratings of pixels relative to a common reference grating to phase-encode a graphical element invisibly into a diffractive optically variable identification device (DOVID), the DOVID comprising a plurality of pixels, each pixel consisting of a periodic micro-grating region and being addressable by an index (i,j), such that the graphical element will be represented in a spatial phase distribution of light diffracted by the DOVID, the method comprising:
inducing and quantifying relative shifts in alignment of grating line positions between pixels with common grating line spacing, L, and grating line orientation and a common periodic reference grating also having the common grating line spacing and grating line orientation, the shifts being induced such that a distribution of encoded relative shift values, sᵢⱼ, represents the graphical element; and
forming the DOVID from at least the pixels with the relative shifts in grating line position.

2-13. (canceled)

14. The method according to claim 1, further comprising providing the graphical element to be invisibly encoded in the form of contrast values, Cₖₗ, for sections in the graphical element, wherein the relative shifts of grating line positions are induced such that the encoded relative shift values, sᵢⱼ, of pixels in the DOVID are a function of the contrast values Cₖₗ of corresponding sections in the graphical element.

15. The method according to claim 1, wherein the positions of the micro-grating regions in the pixels are not shifted.

16. The method according to claim 1, further comprising encoding one or more additional graphical elements visibly into the DOVID using additional pixels having a different grating line spacing and/or grating line orientation and/or grating modulation profiles.

17. The method according to claim 16, wherein said method is performed without changing the grating line position alignment of the pixels with the relative shifts in grating line position.

18. The method according to claim 1, further comprising inducing additional relative shifts of grating line positions in the pixels by adding phase-encrypting shift values s_{c,ij} to the relative shift values, sᵢⱼ.

19. A method for de-coding a graphical element that has been phase-encoded invisibly into a diffractive optically variable identification device (DOVID) comprising a plurality of pixels, each pixel consisting of a periodic micro-grating region and being addressable by an index (i,j), the graphical element having been phase-encoded by inducing relative shifts of grating line positions between pixels, all having common grating line spacing, L, and grating line orientation, and a common periodic reference grating also having the common grating line spacing and grating line orientation, the shifts being induced such that a distribution of encoded relative shift values, sᵢⱼ, represents the graphical element, the method comprising:
irradiating the DOVID with spatially coherent electromagnetic radiation; and
forming a distribution of intensity values, representing the graphical element by inserting into the path of electromagnetic radiation diffracted from the DOVID:
a spatial phase filter for phase shifting a part of incident electromagnetic radiation; and
an imaging system configured to generate, in an image plane of the imaging system, a distribution of intensity values, by interference between the part of incident electromagnetic radiation that has been phase shifted by the phase filter and a remaining part of incident electromagnetic radiation.

20. The method according to claim 19, wherein the phase-encoded graphical element has also been encrypted by inducing additional relative shifts of grating line positions in the pixels by adding phase-encrypting shift values s_{c,ij} to the relative shift values, sᵢⱼ, the method further comprising decryption by inducing a decrypting phase shift distribution, φ_{d,ij}, corresponding to the phase-encrypting shift values s_{c,ij} in electromagnetic radiation diffracted by the DOVID.

21. A reader for reading a graphical element that has been phase-encoded invisibly into a diffractive optically variable identification device (DOVID) comprising a plurality of pixels, each pixel consisting of a periodic micro-grating region and being addressable by an index (i,j), the graphical element having been phase-encoded by inducing relative shifts of grating line positions between pixels, all having common grating line spacing, L, and grating line orientation, and a common periodic reference grating also having the common grating line spacing and grating line orientation, the shifts being induced such that a distribution of encoded relative shift values, sᵢⱼ, represents the graphical element, the reader comprising:
a spatially coherent electromagnetic radiation source arranged to irradiate the DOVID so as to define an optical axis of electromagnetic radiation diffracted from the DOVID;
a spatial phase filter for phase shifting a part of incident electromagnetic radiation and being arranged on said optical axis;
an imaging system arranged on said optical axis and being configured to generate, in an image plane of the imaging system, a distribution of intensity values, by interference between the part of incident electromagnetic radiation that has been phase shifted by the phase filter and a remaining part of incident electromagnetic radiation; and
a detector and/or display for the distribution of intensity values, generated in the image plane of the imaging system.

22. A diffractive optically variable identification device (DOVID) comprising a plurality of pixels, each consisting of a periodic micro-grating region, being addressable by an index (i,j), and having common grating line spacing, L, and grating line orientation, wherein grating line positions in the pixels have been shifted relative to a common periodic reference grating also having the common grating line spacing and grating line orientation such that a distribution of encoded relative shift values, sᵢⱼ, represents a known graphical element whereby the graphical element will be represented in a spatial phase distribution of light diffracted by the DOVID.

23. The DOVID according to claim 22, wherein the graphical element is formed by contrast values, Cₖₗ, for sections in the graphical element, and wherein the encoded relative shift values, sᵢⱼ, of pixels in the DOVID are a function of the contrast values Cₖₗ of corresponding sections in the graphical element.

24. A security kit comprising a DOVID according to claim 22, or a representation thereof, and an electronic representation of the known graphical element.

25. The security kit according to claim 24, wherein phase-encrypting shift values s_{c,ij} has been added to the relative shift values, sᵢⱼ prior to the encoding of these in the DOVID, and wherein the kit further comprises an electronic representation of decryption phasor values, e^{-iφc(i,j)} being related to the phase-encrypting shift values s_{c,ij}.
